(19) United States
(12) Patent Application Publication
(10) Pub. No.: US 2022/0197893 A1
(43) Pub. Date: Jun. 23, 2022

(54) AERIAL VEHICLE AND EDGE DEVICE COLLABORATION FOR VISUAL POSITIONING IMAGE DATABASE MANAGEMENT AND UPDATING

(71) Applicant: HERE Global B.V., Eindhoven (NL)

(72) Inventors: Petri Rauhala, Tampere (FI); Lauri Aarne Johannes Wirola, Tampere (FI); Mike Koivisto, Tampere (FI); Justin Eylander, Chicago, IL (US)

(21) Appl. No.: 17/247,790

(22) Filed: Dec. 23, 2020

(51) Int. Cl. G06F 16/23; G06K 9/00; G06K 9/62; G06T 7/73; G06F 16/587; G06F 16/51

(52) U.S. Cl. CPC G06F 16/2379; G06K 9/0063; G06K 9/6202; G06T 2207/10032; G06T 7/74; G06F 16/587; G06F 16/51; G06K 9/6215

(57) ABSTRACT

A processor obtains image data corresponding to an image captured by an aerial vehicle (AV). The obtained image data comprises a first representation representing at least a portion of surroundings of the AV. The processor accesses existing image data from an image database. The existing image data comprises a second representation. The image database is configured to enable visual positioning. The processor determines, based at least on a comparison of the first representation and the second representation, whether the second representation provides a representation of an environment that at least partially overlaps the at least a portion of the surroundings of the AV; identifies a difference or similarity in the overlap; and generates an update to the image database based on the difference or similarity.

### TECHNOLOGICAL FIELD

An example embodiment relates to updating an image database configured for enabling visual positioning. In particular, an example embodiment generally relates to a collaboration between an aerial vehicle and an edge device to update and/or maintain an image database configured for enabling visual positioning.

### BACKGROUND

In various scenarios, it is contemplated that a drone may be used to perform delivery, pickup, and/or other operations. Use of drones to perform such tasks may be most helpful in urban areas where ground traffic may be difficult to navigate. However, such urban areas also tend to include urban canyons, within which satellite-based positioning technology (e.g., global navigation satellite system (GNSS)) may not be available or reliable.

### BRIEF SUMMARY

Various embodiments provide methods, apparatus, systems, and computer program products for updating or managing an image database configured to enable visual positioning. In various embodiments, the image database is stored by an edge device. An edge device is a computing device which provides an entry or access point to a network. Some non-limiting examples of edge devices include routers, routing switches, integrated access devices, multiplexers, and a variety of metropolitan area network (MAN) and wide area network (WAN) access devices. In various embodiments, the image database is updated based on images captured by aerial vehicles (AV) (e.g., unmanned, automated, semi-automated, and/or other aerial vehicles). In various embodiments, the image database includes images and/or image data corresponding to images captured (e.g., by an AV) within a broadcast region of the edge device. For example, the image database, stored by an edge device, may only store images and/or image data that enable visual positioning within a broadcast region of the edge device.

In various embodiments, an AV traveling through a geographical area may capture an image and/or a stream of images and provide the image and/or the stream of images to an edge device that is located within a broadcast range of the AV. In an example embodiment, the AV provides the image and/or stream of images using a 5G protocol transmission. In an example embodiment, the AV provides the image and/or stream of images using a short range or peer-to-peer 5G protocol transmission. For example, the AV may be located within a broadcast region of the edge device, wherein the broadcast region of the edge device is a geographical region within which the AV (or another device, such as a computing device) can communicate with the edge device via the 5G protocol transmission (e.g., short range and/or peer-to-peer 5G protocol transmission). The image, or each image of the stream of images, is captured by an image device disposed on and/or physically associated with the AV. The image, or each image of the stream of images, corresponds to at least a portion of surroundings of the AV. For example, the image, or each stream of images, may provide an aerial view of at least a portion of the surroundings of the AV. In various embodiments, image data corresponding to the image may be provided. In an example embodiment, the image data comprises a representation of at least a portion of the surroundings of the AV. In various embodiments, the representation of the at least a portion of the surroundings of the AV may be a color-coded pixel array; a representation of a boundary, edge, line, and/or the like identified in the corresponding image data; and/or other information encoding a representation of the at least a portion of the surroundings of the AV as captured in the corresponding image.

In various embodiments, an edge device may obtain and/or receive image data corresponding to images captured by one or more AVs within the broadcast region of the edge device. The edge device may access an image database stored by the edge device (e.g., in local memory) to identify existing image data stored in the image database that corresponds to a representation of an environment that at least partially overlaps the at least a portion of the surroundings of the AV represented in the image data obtained and/or received by the edge device. The existing image data and the obtained and/or received image data may be compared to identify and/or determine one or more differences and/or similarities between the representation of the surroundings of the AV provided by the first representation corresponding to the obtained and/or received image data and the environment that at least partially overlaps the at least a portion of the surroundings of the AV provided by the second representation corresponding to the existing image data. For example, the differences between the second representation and the first representation and/or the overlapping portions thereof may indicate changes to the environment, features that may not be static and/or stable with time, and/or the like. For example, the similarities between the second representation and the first representation and/or the overlapping portions thereof may indicate features within the environment that are static and/or stable (at least with regard to a time frame between the capturing of an image corresponding to the existing image data and the capturing of the image corresponding to the obtained and/or received image data). In an example embodiment, the edge device may compare image data corresponding to two images captured by the same AV (e.g., as part of the same stream of images and/or at different instances of the AV being located within the broadcast region of the edge device) or captured by two different AVs.

Based on the identified differences and/or similarities, updates to the image database may be generated. The image database may then be updated based on the generated update. In an example embodiment, the same difference and/or similarity may be identified in comparing the existing image data to multiple instances of obtained and/or received image data within a time period before the image database is updated based on the generated update. In various embodiments, point of interest (POI) information/data may be extracted from one or more images and/or image data stored in the image database. The extracted POI information/data may be used to update a geographic database, digital map, and/or the like.

The image database may be used to enable visual positioning of an AV or other computing device. For example, in an example embodiment, the edge device may be configured to transform an aerial image stored in the image database to a street perspective view image based on a street perspective view request. In an example embodiment, the street perspective view image may be used to determine a position estimate for a ground-based computing device (e.g., a vehicle device onboard a ground vehicle, a mobile phone, and/or the like). In an example embodiment, the street perspective view image may be provided by the edge device such that the mobile device receives the street perspective view image and displays the street perspective view image and/or otherwise uses the street perspective view image to perform one or more positioning and/or navigation-related functions. Some non-limiting examples of positioning and/or navigation-related functions include localization, route determination, lane level route determination, operating a vehicle along a lane level route, route travel time determination, lane maintenance, route guidance, lane level route guidance, provision of traffic information/data, provision of lane level traffic information/data, vehicle trajectory determination and/or guidance, vehicle speed and/or handling control, route and/or maneuver visualization, provision of safety alerts, display of an icon or symbol indicating the location of a mobile device overlaid on a visualization of a portion of a digital map, and/or the like. In an example embodiment, performing the positioning and/or navigation-related function comprises displaying the street perspective view as part of a see-through virtual reality display that may be part of a route guidance user interface.

In an example embodiment, one or more processors obtain image data corresponding to at least one image captured by an AV. The obtained image data comprises a first representation that provides a representation of at least a portion of surroundings of the AV. The one or more processors access existing image data from an image database. The existing image data comprises a second representation. The image database is configured to at least enable visual positioning of a device. The one or more processors determine whether the second representation provides a representation of an environment that at least partially overlaps the at least a portion of the surroundings of the AV based at least in part on a comparison of the first representation and the second representation. The one or more processors identify at least one difference or similarity in an overlap of the representation of the environment and the at least a portion of the surroundings of the AV based at least in part on the determination of whether the second representation represents an environment that at least partially overlaps the at least a portion of the surroundings of the AV. The one or more processors generate an update to the image database based at least in part on the at least one difference or similarity.

According to an aspect of the present disclosure, a method is provided. In an example embodiment, the method comprises obtaining, by one or more processors, image data corresponding to at least one image captured by an aerial vehicle (AV). The obtained image data comprises a first representation that provides a representation of at least a portion of surroundings of the AV. The method further comprises accessing, by the one or more processors, existing image data from an image database. The existing image data comprises a second representation. The image database is configured to at least enable visual positioning of a device. The method further comprises determining, by the one or more processors, based at least in part on a comparison of the first representation and the second representation, whether the second representation provides a representation of an environment that at least partially overlaps the at least a portion of the surroundings of the AV. The method further comprises based at least in part on the determination of whether the second representation represents an environment that at least partially overlaps the at least a portion of the surroundings of the AV, identifying, by the one or more processors, at least one difference or similarity in an overlap of the representation of the environment and the at least a portion of the surroundings of the AV; and generating, by the one or more processors, an update to the image database based at least in part on the at least one difference or similarity.

In an example embodiment, the method further comprises, based at least in part on the determination of whether the second representation represents an environment that at least partially overlaps the at least a portion of the surroundings of the AV, determining a position estimate for the AV. In an example embodiment, the one or more processors are part of an edge device. In an example embodiment, the edge device stores the image database and the image database comprises image data corresponding to an environment within a broadcast region of the edge device. In an example embodiment, the broadcast region corresponds to a broadcast range of at least one of short range 5G transmissions or peer-to-peer 5G transmissions. In an example embodiment, the method further comprises generating an updated database by updating the image database based on the generated update; and, optionally, extracting point of interest data from image data stored in the updated database.

In an example embodiment, the at least one image is a part of a stream of images. In an example embodiment, each of the first representation and the second representation comprise at least one of (a) a color-coded pixel array or (b) a representation of a boundary identified in the corresponding image data. In an example embodiment, the method further comprises analyzing the at least one image to generate the first representation. In an example embodiment, the image data comprises a plurality of instances of image data that each correspond to a respective at least one image that provides a representation that overlaps at least in part with the environment, and the method further comprises determining a plurality of differences and/or similarities in the overlap of at least one of (a) one or more pairs of instances of image data of the plurality of instances of image data or (b) one or more instances of image data of the plurality of instances of image data and the existing image data, wherein the update to the image database is generated based on the plurality of differences and/or similarities.

In an example embodiment, the at least one image provides an aerial view of the at least a portion of the surroundings of the AV and the existing image data stored in the image database provides an aerial view of the environment. In an example embodiment, the method further comprises transforming the aerial view of the environment to a street perspective view and providing the street perspective view such that the street perspective view is received by a computing device for use in a positioning and/or navigation-related function. In an example embodiment, the computing device is configured to provide the street perspective view via a display thereof. In an example embodiment, the street perspective view is provided as part of a see-through virtual reality display.

According to another aspect of the present disclosure, an apparatus is provided. In an example embodiment, the apparatus comprises at least one processor, at least one memory storing computer program code, and a communications interface. The at least one memory and the computer program code are configured to, with the processor, cause the apparatus to at least obtain image data corresponding to at least one image captured by an aerial vehicle (AV). The obtained image data comprising a first representation that provides a representation of at least a portion of surroundings of the AV. The at least one memory and the computer program code are further configured to, with the processor, cause the apparatus to at least access existing image data from an image database. The existing image data comprises a second representation. The image database is configured to at least enable visual positioning of a device. The at least one memory and the computer program code are further configured to, with the processor, cause the apparatus to at least determine based at least in part on a comparison of the first representation and the second representation, whether the second representation provides a representation of an environment that at least partially overlaps the at least a portion of the surroundings of the AV. The at least one memory and the computer program code are further configured to, with the processor, cause the apparatus to at least, based at least in part on the determination of whether the second representation represents an environment that at least partially overlaps the at least a portion of the surroundings of the AV, identify at least one difference or similarity in an overlap of the representation of the environment and the at least a portion of the surroundings of the AV; and generate an update to the image database based at least in part on the at least one difference or similarity.

In an example embodiment, the at least one memory and the computer program code are further configured to, with the processor, cause the apparatus to at least, based at least in part on the determination of whether the second representation represents an environment that at least partially overlaps the at least a portion of the surroundings of the AV, determine a position estimate for the AV. In an example embodiment, the apparatus is an edge device. In an example embodiment, the edge device stores the image database in the at least one memory and the image database comprises image data corresponding to an environment within a broadcast region of the edge device. In an example embodiment, the broadcast region corresponds to a broadcast range of at least one of short range 5G transmissions or peer-to-peer 5G transmissions. In an example embodiment, the at least one memory and the computer program code are further configured to, with the processor, cause the apparatus to at least generate an updated database by updating the image database based on the generated update; and, optionally, extract point of interest data from image data stored in the updated database.

In an example embodiment, the at least one image is a part of a stream of images. In an example embodiment, each of the first representation and the second representation comprise at least one of (a) a color-coded pixel array or (b) a representation of a boundary identified in the corresponding image data. In an example embodiment, the at least one memory and the computer program code are further configured to, with the processor, cause the apparatus to at least analyze the at least one image to generate the first representation. In an example embodiment, the image data comprises a plurality of instances of image data that each correspond to a respective at least one image that provides a representation that overlaps at least in part with the environment, and the method further comprises determining a plurality of differences and/or similarities in the overlap of at least one of (a) one or more pairs of instances of image data of the plurality of instances of image data or (b) one or more instances of image data of the plurality of instances of image data and the existing image data, wherein the update to the image database is generated based on the plurality of differences and/or similarities.

In an example embodiment, the at least one image provides an aerial view of the at least a portion of the surroundings of the AV and the existing image data stored in the image database provides an aerial view of the environment. In an example embodiment, the at least one memory and the computer program code are further configured to, with the processor, cause the apparatus to at least transform the aerial view of the environment to a street perspective view and provide the street perspective view such that the street perspective view is received by a computing device for use in a positioning and/or navigation-related function. In an example embodiment, the computing device is configured to provide the street perspective view via a display thereof. In an example embodiment, the street perspective view is provided as part of a see-through virtual reality display.

In still another aspect of the present disclosure, a computer program product is provided. In an example embodiment, the computer program product comprises at least one non-transitory computer-readable storage medium having computer-readable program code portions stored therein. The computer-readable program code portions comprise executable portions configured, when executed by a processor of an apparatus, to cause the apparatus to obtain image data corresponding to at least one image captured by an aerial vehicle (AV). The obtained image data comprising a first representation that provides a representation of at least a portion of surroundings of the AV. The computer-readable program code portions comprise executable portions further configured, when executed by a processor of an apparatus, to cause the apparatus to access existing image data from an image database. The existing image data comprises a second representation. The image database is configured to at least enable visual positioning of a device. The computer-readable program code portions comprise executable portions further configured, when executed by a processor of an apparatus, to cause the apparatus to determine based at least in part on a comparison of the first representation and the second representation, whether the second representation provides a representation of an environment that at least partially overlaps the at least a portion of the surroundings of the AV. The computer-readable program code portions comprise executable portions further configured, when executed by a processor of an apparatus, to cause the apparatus to, based at least in part on the determination of whether the second representation represents an environment that at least partially overlaps the at least a portion of the surroundings of the AV, identify at least one difference or similarity in an overlap of the representation of the environment and the at least a portion of the surroundings of the AV; and generate an update to the image database based at least in part on the at least one difference or similarity.

In an example embodiment, the computer-readable program code portions comprise executable portions further configured, when executed by a processor of an apparatus, to cause the apparatus to, based at least in part on the determination of whether the second representation represents an environment that at least partially overlaps the at least a portion of the surroundings of the AV, determine a position estimate for the AV. In an example embodiment, the apparatus is an edge device. In an example embodiment, the edge device stores the image database in the at least one memory and the image database comprises image data corresponding to an environment within a broadcast region of the edge device. In an example embodiment, the broadcast region corresponds to a broadcast range of at least one of short range 5G transmissions or peer-to-peer 5G transmissions. In an example embodiment, the computer-readable program code portions comprise executable portions further configured, when executed by a processor of an apparatus, to cause the apparatus to generate an updated database by updating the image database based on the generated update; and, optionally, extract point of interest data from image data stored in the updated database.

In an example embodiment, the at least one image is a part of a stream of images. In an example embodiment, each of the first representation and the second representation comprise at least one of (a) a color-coded pixel array or (b) a representation of a boundary identified in the corresponding image data. In an example embodiment, the computer-readable program code portions comprise executable portions further configured, when executed by a processor of an apparatus, to cause the apparatus to analyze the at least one image to generate the first representation. In an example embodiment, the image data comprises a plurality of instances of image data that each correspond to a respective at least one image that provides a representation that overlaps at least in part with the environment, and the method further comprises determining a plurality of differences and/or similarities in the overlap of at least one of (a) one or more pairs of instances of image data of the plurality of instances of image data or (b) one or more instances of image data of the plurality of instances of image data and the existing image data, wherein the update to the image database is generated based on the plurality of differences and/or similarities.

In an example embodiment, the at least one image provides an aerial view of the at least a portion of the surroundings of the AV and the existing image data stored in the image database provides an aerial view of the environment. In an example embodiment, the computer-readable program code portions comprise executable portions further configured, when executed by a processor of an apparatus, to cause the apparatus to transform the aerial view of the environment to a street perspective view and provide the street perspective view such that the street perspective view is received by a computing device for use in a positioning and/or navigation-related function. In an example embodiment, the computing device is configured to provide the street perspective view via a display thereof. In an example embodiment, the street perspective view is provided as part of a see-through virtual reality display.

According to yet another aspect of the present disclosure, an apparatus is provided. In an example embodiment, the apparatus comprises means for obtaining image data corresponding to at least one image captured by an aerial vehicle (AV). The obtained image data comprises a first representation that provides a representation of at least a portion of surroundings of the AV. The apparatus comprises means for accessing existing image data from an image database. The existing image data comprises a second representation. The image database is configured to at least enable visual positioning of a device. The apparatus comprises means for determining, based at least in part on a comparison of the first representation and the second representation, whether the second representation provides a representation of an environment that at least partially overlaps the at least a portion of the surroundings of the AV. The apparatus comprises means for, based at least in part on the determination of whether the second representation represents an environment that at least partially overlaps the at least a portion of the surroundings of the AV, identifying at least one difference or similarity in an overlap of the representation of the environment and the at least a portion of the surroundings of the AV. The apparatus comprises means for generating an update to the image database based at least in part on the at least one difference or similarity.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example system of one embodiment of the present disclosure;

FIG. 2A is a block diagram of an edge device that may be specifically configured in accordance with an example embodiment;

FIG. 2B is a block diagram of a computing device that may be specifically configured in accordance with an example embodiment;

FIG. 2C is a block diagram of an aerial vehicle (AV) that may be specifically configured in accordance with an example embodiment;

FIG. 3 is a flowchart illustrating operations performed, such as by the AV of FIG. 2C, to provide image data, in accordance with an example embodiment;

FIG. 4 is a flowchart illustrating operations performed, such as by the edge device of FIG. 2A, to update an image database, in accordance with an example embodiment;

FIGS. 5A and 5B illustrate example corresponding first and second representations, respectively, in accordance with an example embodiment;

FIG. 6 is a flowchart illustrating operations performed, such as by the edge device of FIG. 2A, to provide a street perspective view image based on image data stored in the image database, in accordance with an example embodiment;

FIG. 7 is a flowchart illustrating operations performed, such as by the computing device of FIG. 2B, to display a street perspective view image, in accordance with an example embodiment; and

FIG. 8 provides an example route guidance user interface that may be displayed, for example, by a computing device of FIG. 2B, in accordance with an example embodiment.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. Like reference numerals refer to like elements throughout. As used herein, the terms “data,” “content,” “information,” and similar terms may be used interchangeably to refer to data capable of being transmitted, received and/or stored in accordance with embodiments of the present invention. As used herein, the terms “substantially” and “approximately” refer to values and/or tolerances that are within manufacturing and/or engineering guidelines and/or limits. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware.

### I. General Overview

Methods, apparatus and computer program products are provided in accordance with an example embodiment in order to manage and/or update an image database configured to enable visual positioning of a device (e.g., an AV, a computing device, and/or the like). In various embodiments, the image database is stored by an edge device. An edge device is a computing device which provides an entry or access point to a network. Some non-limiting examples of edge devices include routers, routing switches, integrated access devices, multiplexers, and a variety of metropolitan area network (MAN) and wide area network (WAN) access devices. In various embodiments, the image database is updated based on images captured by aerial vehicles (AV) (e.g., unmanned, automated, semi-automated, and/or other aerial vehicles). In an example embodiment, the image database stores images and/or image data corresponding to images captured within a broadcast region of the edge device. In various embodiments, a broadcast region of the edge device is defined by a broadcast range (e.g., a distance from the edge device at which the strength of a signal generated and/or transmitted by the edge device reaches an observable threshold value). In various embodiments, the broadcast region is a geographical region within which a device (e.g., an AV, computing device, and/or the like) can use the edge device as an access point to the corresponding network. For example, the broadcast region may be the geographical region within which a device (e.g., an AV, computing device, and/or the like) may communicate via a direct wireless connection with the edge device. In various embodiments, the image database includes images and/or image data corresponding to images captured (e.g., by an AV) within a broadcast region of the edge device. For example, the image database, stored by an edge device, may only store images and/or image data that enable visual positioning within a broadcast region of the edge device.

In various embodiments, an AV traveling through a broadcast region of an edge device may capture an image and/or a stream of images and provide the image and/or the stream of images and/or image data corresponding thereto to the edge device. In an example embodiment, broadcast regions of two or more edge devices may overlap and, when the AV is located within the overlap of the broadcast regions, the AV may provide images and/or image data to one or more of the edge devices corresponding to the overlapping broadcast regions. In an example embodiment, the AV provides the image and/or stream of images and/or image data corresponding thereto using a 5G protocol transmission. In an example embodiment, the AV provides the image and/or stream of images and/or image data corresponding thereto using a short range or peer-to-peer 5G protocol transmission. The image, or each image of the stream of images, is captured by an image device disposed on and/or physically associated with the AV. The image, or each image of the stream of images, corresponds to at least a portion of surroundings of the AV. For example, the image, or each image of the stream of images, may provide an aerial view of at least a portion of the surroundings of the AV. In various embodiments, image data corresponding to an image comprises a representation of the at least a portion of the surroundings of the AV corresponding to the image (e.g., pictured in the image). For example, the image data may provide an representation or an encoding of the at least a portion of the surroundings of the AV that are pictured in the corresponding image. In various embodiments, the representation of the at least a portion of the surroundings of the AV may be a color-coded pixel array; a representation of a boundary, edge, line, and/or the like identified in the corresponding image data; and/or other information encoding a representation of the at least a portion of the surroundings of the AV as captured in the corresponding image.

In various embodiments, an edge device may obtain and/or receive image data corresponding to images captured by one or more AVs within the broadcast region of the edge device. The edge device may access an image database stored by the edge device (e.g., in local memory) to identify existing image data stored in the image database that corresponds to a representation of an environment that at least partially overlaps the at least a portion of the surroundings of the AV represented in the image data obtained and/or received by the edge device. The existing image data and the obtained and/or received image data may be compared to identify and/or determine one or more differences and/or similarities between the representation of the surroundings of the AV provided by the first representation corresponding to the obtained and/or received image data and the environment that at least partially overlaps the at least a portion of the surroundings of the AV provided by the second representation corresponding to the existing image data. For example, the differences between the second representation and the first representation and/or the overlapping portions thereof may indicate changes to the environment, features that may not be static and/or stable with time, and/or the like. For example, the similarities between the second representation and the first representation and/or the overlapping portions thereof may indicate features within the environment that are static and/or stable (at least with regard to a time frame between the capturing of an image corresponding to the existing image data and the capturing of the image corresponding to the obtained and/or received image data). In an example embodiment, the edge device may compare image data corresponding to two images captured by the same AV (e.g., as part of the same stream of images and/or at different instances of the AV being located within the broadcast range of the edge device) or captured by two different AVs.

Based on the identified differences and/or similarities between the overlapping portions of the first and second representations, updates to the image database may be generated. The image database may then be updated based on the generated update. In an example embodiment, the same difference and/or similarity may be identified in comparing the existing image data to multiple instances of obtained and/or received image data within a time period before the image database is updated based on the generated update. In various embodiments, point of interest (POI) information/data may be extracted from one or more images and/or image data stored in the image database. The extracted POI information/data may be used to update a geographic database, digital map, and/or the like.

The image database may be used to enable visual positioning of an AV or other computing device. For example, in an example embodiment, the edge device may be configured to transform an aerial image stored in the image database to a street perspective view image based on a street perspective view request. In an example embodiment, the street perspective view image may be used to determine a position estimate for a ground-based computing device (e.g., a vehicle device onboard a ground vehicle, a mobile phone, and/or the like). In an example embodiment, the street perspective view image may be provided by the edge device such that the mobile device receives the street perspective view image and displays the street perspective view image and/or otherwise uses the street perspective view image to perform one or more positioning and/or navigation-related functions. Some non-limiting examples of positioning and/or navigation-related functions include localization, route determination, lane level route determination, operating a vehicle along a lane level route, route travel time determination, lane maintenance, route guidance, lane level route guidance, provision of traffic information/data, provision of lane level traffic information/data, vehicle trajectory determination and/or guidance, vehicle speed and/or handling control, route and/or maneuver visualization, provision of safety alerts, display of an icon or symbol indicating the location of a mobile device overlaid on a visualization of a portion of a digital map, and/or the like. In an example embodiment, performing the positioning and/or navigation-related function comprises displaying the street perspective view as part of a see-through virtual reality display that may be part of a route guidance user interface.

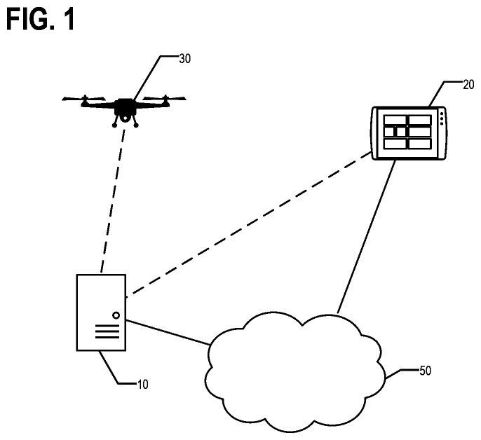

FIG. 1 provides an illustration of an example system that can be used in conjunction with various embodiments of the present invention. As shown in FIG. 1, the system may include one or more edge devices 10, one or more computing devices 20, one or more AVs 30, one or more networks 50, and/or the like. In various embodiments, an AV 30 may be an unmanned, autonomous, semi-autonomous, and/or other aerial vehicle. In various embodiments, the AV 30 may capture images as the AV 30 travels through a geographic area and provide one or more images and/or corresponding image data to an edge device 10 corresponding to a broadcast region within which the one or more images were captured, and/or the like. In various embodiments, a computing device 20 may be a user device, mobile device, and/or other computing entity that may be used to perform one or more positioning and/or navigation-related functions, such as displaying a route guidance user interface. In an example embodiment, the edge device 10 is a network entry and/or access point. For example, the edge device 10 may be in direct communication with one or more AVs 30 and/or one or more computing devices 20 via a wireless communication protocol. For example, the wireless communication protocol may be a 5G protocol, short range 5G protocol, peer-to-peer 5G protocol, and/or the like. In an example embodiment, edge device 10 may be in communication with one or more computing devices 20, one or more AVs 30, and/or the like via one or more wired or wireless networks 50.

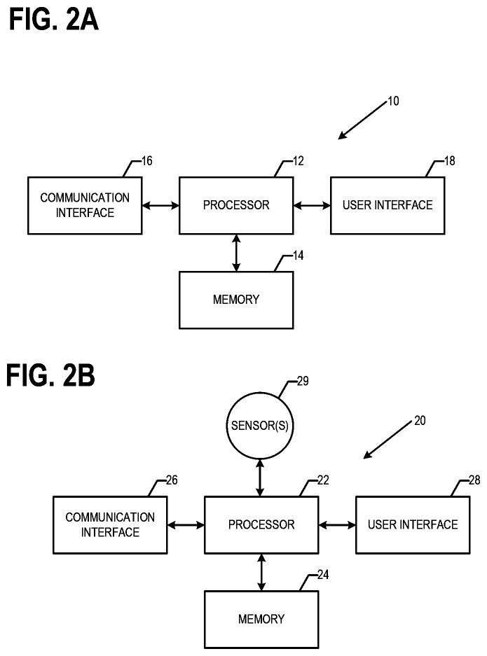

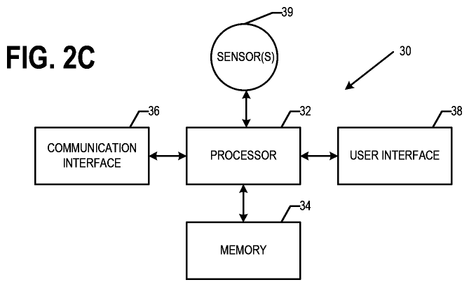

In an example embodiment, an edge device 10 may comprise components similar to those shown in the example edge device 10 diagrammed in FIG. 2A. In an example embodiment, the edge device 10 is configured to obtain and/or receive image data comprising a first representation, compare the first representation to a corresponding (e.g., at least partially overlapping) second representation to identify similarities and/or differences therebetween, generate updates to an image database based on the identified similarities and/or differences, generate street perspective view images based on aerial image data stored in the image database, and/or the like.

For example, as shown in FIG. 2A, the edge device 10 may comprise a processor 12, memory 14, a user interface 18, a communications interface 16, and/or other components configured to perform various operations, procedures, functions or the like described herein. In various embodiments, the edge device 10 stores an image database (e.g., in memory 14). In at least some example embodiments, the memory 14 is non-transitory.

In an example embodiment, a computing device 20 is a user computing device, mobile computing device, and/or other computing device configured to perform one or more positioning and/or navigation-related functions, such as displaying a route guidance user interface. In an example embodiment, the computing device 20 may be configured to generate and/or provide a street perspective view image request, receive a street perspective view image, use the street perspective view image to perform at least one positioning and/or navigation-related function, and/or the like. In an example embodiment, as shown in FIG. 2B, the computing device 20 may comprise a processor 22, memory 24, a communications interface 26, a user interface 28, one or more sensors 29 and/or other components configured to perform various operations, procedures, functions or the like described herein. In various embodiments, the computing device 20 stores at least a portion of one or more digital maps (e.g., geographic databases, positioning maps, and/or the like) in memory 24. In at least some example embodiments, the memory 24 is non-transitory.

In various embodiments, the sensors 29 comprise one or more location sensors such as a GNSS sensor, inertial measurement unit (IMU) sensors (e.g., accelerometers, gyroscopes, magnetometers, and/or the like), altimeters, and/or the like. In various embodiments, the sensors 29 comprise one or more image sensors configured to capture visual samples, such as digital camera(s), 3D cameras, 360° cameras, and/or image sensors. In various embodiments, the one or more sensors 29 may comprise one or more interfaces, such as radio interfaces, configured to observe and/or receive signals generated and/or transmitted by one or more access points and/or other computing entities (e.g., edge device 10). For example, the one or more interfaces may be configured (possibly in coordination with processor 22) to determine an access point and/or emitting device identifier configured to identify the access point and/or emitting device that generated and/or transmitted a signal observed by the computing device 20, a signal strength of the signal observed by the computing device 20, a one way or round trip time value for a signal observed by the computing device 20, and/or the like. As used herein, when a computing device 20 observes an access point and/or emitting device, the computing device 20 has observed a signal generated and/or transmitted by the access point and/or emitting device. In an example embodiment, the interface may be configured to observe one or more types of signals such as generated and/or transmitted in accordance with one or more protocols such as 5G, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. For example, the interface may be configured to observe signals of one or more modern global cellular formats such as GSM, WCDMA, TD-SCDMA, LTE, LTE-A, CDMA, NB-IoT and/or non-cellular formats such as WLAN, Bluetooth, Bluetooth Low Energy (BLE), Zigbee, Lora, and/or the like. For example, the interface may be configured to observe radio, millimeter, microwave, and/or infrared wavelength signals. In an example embodiment, the interface may be coupled to and/or part of a communications interface 26. In various embodiments, the sensors 29 may comprise various other sensors such as two dimensional (2D) and/or three dimensional (3D) light detection and ranging (LiDAR)(s), long, medium, and/or short range radio detection and ranging (RADAR), ultrasonic sensors, electromagnetic sensors, (near-) infrared (IR) cameras.

In an example embodiment, an AV 30 is an unmanned, autonomous, semi-autonomous, and/or other aerial vehicle. For example, the AV 30 may be a drone, in an example embodiment. In an example embodiment, the AV 30 may be configured to capture an image and/or stream of images and provide the image and/or stream of images and/or image data corresponding thereto such that an edge device 10 receives the image data and/or stream of images and/or image data corresponding thereto. In an example embodiment, the AV 30 is configured to receive a positioning estimate provided by the edge device 10 and perform one or more positioning and/or navigation-related functions based on and/or using the positioning estimate. In an example embodiment, as shown in FIG. 2C, the AV 30 may comprise a processor 32, memory 34, a communications interface 36, a user interface 38, one or more sensors 39 and/or other components configured to perform various operations, procedures, functions or the like described herein. In various embodiments, the AV 30 stores at least a portion of one or more digital maps (e.g., geographic databases, positioning maps, and/or the like) and/or computer executable instructions for performing one or more radio environment signature generation and/or comparison functions and/or validation data object generation functions in memory 34. In at least some example embodiments, the memory 34 is non-transitory. The AV 30 may further comprise various components for controlling the AV 30, causing the AV 30 to fly along a route, cause the AV 30 to pick up and carry and/or transport an item from a first location to a second location, cause the AV 30 to leave the item at the second location, and/or the like. For example, the AV 30 may comprise one or more item transporting components and corresponding executable instructions for operation thereof may be stored in memory 34. For example, the AV 30 may comprise one or more flying systems and/or vehicle control and/or routing systems and corresponding executable instructions may be stored in memory 34.

In various embodiments, the sensors 39 comprise one or more location sensors such as a GNSS sensor, inertial measurement unit (IMU) sensors (e.g., accelerometers, gyroscopes, magnetometers, and/or the like), altimeters, and/or the like. In various embodiments, the sensors 39 comprise one or more image sensors configured to capture visual samples, such as digital camera(s), 3D cameras, 360° cameras, and/or image sensors. In various embodiments, the one or more sensors 39 may comprise one or more interfaces, such as radio interfaces, configured to observe and/or receive signals generated and/or transmitted by one or more access points and/or other computing entities (e.g., computing device 20). For example, the one or more interfaces may be configured (possibly in coordination with processor 32) to determine an access point and/or emitting device identifier configured to identify the access point and/or emitting device that generated and/or transmitted a signal observed by the AV 30, a signal strength of the signal observed by the AV 30, a one way or round trip time value for a signal observed by the AV 30, and/or the like. As used herein, when an AV 30 observes an access point and/or emitting device, the AV 30 has observed a signal generated and/or transmitted by the access point and/or emitting device. In an example embodiment, the interface may be configured to observe one or more types of signals such as generated and/or transmitted in accordance with one or more protocols such as 5G, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. For example, the interface may be configured to observe signals of one or more modern global cellular formats such as GSM, WCDMA, TD-SCDMA, LTE, LTE-A, CDMA, NB-IoT and/or non-cellular formats such as WLAN, Bluetooth, Bluetooth Low Energy (BLE), Zigbee, Lora, and/or the like. For example, the interface may be configured to observe radio, millimeter, microwave, and/or infrared wavelength signals. In an example embodiment, the interface may be coupled to and/or part of a communications interface 36. In various embodiments, the sensors 39 may comprise various other sensors such as two dimensional (2D) and/or three dimensional (3D) light detection and ranging (LiDAR)(s), long, medium, and/or short range radio detection and ranging (RADAR), ultrasonic sensors, electromagnetic sensors, (near-) infrared (IR) cameras.

In an example embodiment, the edge device 10 communicates with the AV 30 and/or computing device 20 via a direct wireless communication protocol. For example, the edge device 10 may be configured to transmit and receive signals (e.g., radio wavelength signals) carrying information/data in accordance with a wireless communication protocol. Similarly, the AV 30 and/or computing device 20 may be configured to receive and/or transmit signals (e.g., radio wavelength signals) carrying information/data in accordance with the wireless communication protocol. In an example embodiment, the wireless communication protocol is a 5G protocol. In various embodiments, a variety of wireless communication protocols may be used.

Each of the components of the system may be in electronic communication with, for example, one another over the same or different wireless or wired networks 50 including, for example, a wired or wireless Personal Area Network (PAN), Local Area Network (LAN), Metropolitan Area Network (MAN), Wide Area Network (WAN), cellular network, and/or the like. In an example embodiment, a network 50 comprises the automotive cloud, digital transportation infrastructure (DTI), radio data system (RDS)/high definition (HD) radio or other digital radio system, and/or the like. For example, a computing device 20 and/or AV 30 may be in communication with an edge device 10 via the network 50. For example, a computing device 20 and/or AV 30 may communicate with the edge device 10 via a network, such as the Cloud. In an example embodiment, the computing device 20 and/or AV 30 may access a network, such as the Cloud, via the edge device 10. For example, the Cloud may be a computer network that provides shared computer processing resources and data to computers and other devices connected thereto. For example, the computing device 20 and/or AV 30 may be configured to provide and/or receive one or more images, image data, street perspective view images, and/or the like via the network 50. For example, the edge device 10 may configured to receive and/or provide one or more images and/or image data and/or provide position estimates and/or street perspective view images via the network 50. In various embodiments, the AV 30 and computing device 20 may communicate with the edge device 10 via a 5G protocol such as a short range 5G protocol, a 5G peer-to-peer protocol, and/or the like.

Certain example embodiments of the edge device 10, computing device 20, and AV 30 are described in more detail below with respect to FIGS. 2A, 2B, and 2C.

### II. Example Operation(s)

In various scenarios, such as navigating an urban canyon or an indoor environment, an AV 30 may not be able to rely on GNSS-based positioning techniques. In various embodiments, an AV 30 may be configured to use a visual positioning technique in addition to and/or as an alternative to a GNSS-based positioning technique. For example, as an AV 30 navigates a geographical area, the AV 30 may capture one or more images and/or a stream of images (e.g., via a camera and/or other image sensor 29). In an example embodiment, the AV 30 may transmit and/or broadcast the one or more images and/or stream of images and/or image data corresponding thereto to one or more edge devices 10 of which the AV 30 is located within a corresponding broadcast region. For example, an edge device 10 may be disposed at a constant location (e.g., the edge device 10 may not a mobile device, in an example embodiment) and be capable of communicating with other devices (e.g., AV 30, computing device 20) via direct wireless communication (e.g., 5G, 5G short range, 5G peer-to-peer, and/or the like) when the other devices are located within the broadcast region of the edge device 10. For example, the AV 30 and/or a computing device 20 may be able to communicate with the edge device 10 via a direct wireless communication (e.g., 5G, 5G short range, 5G peer-to-peer, and/or the like) when the AV 30 and/or computing device 20 is located within the broadcast region of the edge device 10.

The edge device 10 may receive the image and/or stream of images and/or image data corresponding thereto provided by the AV 30 (e.g., via the direct wireless communication). When the edge device 10 receives and image and/or stream of images, the edge device 10 may process and/or analyze the image and/or stream of images to generate corresponding image data. In an example embodiment, the image data comprises a first representation that represents a portion of the surroundings of the AV 30 that is pictured in the corresponding image. In various embodiments, the first representation may comprise a color-coded pixel array; a representation of a boundary, edge, line, and/or the like identified in the corresponding image data; and/or other information encoding a representation of the at least a portion of the surroundings of the AV 30 as captured in the corresponding image. The edge device 10 may access existing image data from an image database stored in local memory of the edge device 10 (e.g., memory 14). The existing image data may comprise a second representation. In various embodiments, the second representation provides a representation of an environment located within and/or visible from the broadcast region of the edge device 10. For example, the image database stored by the edge device 10 may comprise image data corresponding to and/or generated based on images that were captured from within the broadcast region of the edge device 10.

The edge device 10 may determine whether the environment represented by the second representation of the existing image data overlaps at least in part with the portion of the surroundings of the AV that are represented by the first representation of the obtained and/or received image data. When the edge device 10 determines that the environment represented by the second representation overlaps at least in part with the portion of the surroundings of the AV 30 that are represented by the first representation, the edge device 10 may compare, analyze, process, and/or the like the overlap portion between the two representations to identify one or more differences and/or similarities between the first representation and the second representation. For example, the differences between the second representation and the first representation and/or the overlapping portions thereof may indicate changes to the environment, features that may not be static and/or stable with time, and/or the like. For example, the similarities between the second representation and the first representation and/or the overlapping portions thereof may indicate features within the environment that are static and/or stable (at least with regard to a time frame between the capturing of an image corresponding to the existing image data and the capturing of the image corresponding to the obtained and/or received image data). In an example embodiment, the edge device may compare image data corresponding to two images captured by the same AV (e.g., as part of the same stream of images and/or at different instances of the AV being located within the broadcast region of the edge device) or captured by two different AVs.

Based on the identified differences and/or similarities between the overlapping portions of the first and second representations, updates to the image database may be generated. The image database may then be updated based on the generated update. In an example embodiment, the same difference and/or similarity may be identified in comparing the existing image data to multiple instances of obtained and/or received image data within a time period before the image database is updated based on the generated update. In various embodiments, point of interest (POI) information/data may be extracted from one or more images and/or image data stored in the image database. The extracted POI information/data may be used to update a geographic database, digital map, and/or the like.

In various embodiments, information/data and/or images stored in the image database stored by the edge device 10 may be used to perform visual positioning and/or other positioning and/or navigation-related functions within the vicinity of the edge device 10 (e.g., within the broadcast region and/or near the perimeter of the broadcast region (e.g., the area outside of the broadcast region that is visible from within the broadcast region). For example, the visual positioning and/or other positioning and/or navigation-related functions may be performed for and/or by one or more AVs 30 using information/data and/or images stored in the image database stored by the edge device 10. In another example, the visual positioning and/or other positioning and/or navigation-related functions may be performed for and/or by one or more computing devices 20 using information/data and/or images stored in the image database stored by the edge device 10.

### A. Example Operation of an Aerial Vehicle

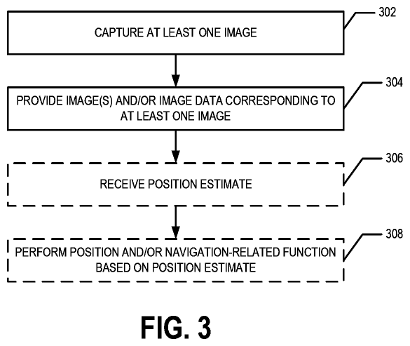

FIG. 3 provides a flowchart illustrating various processes, procedures, operations, and/or the like that may be performed by an AV 30 in various embodiments. Starting at block 302, as an AV 30 is traveling and/or navigating through a geographic area, the AV 30 may capture an image and/or a stream of images. Each image may picture and/or correspond to a portion of the surroundings of the AV 30 at the moment and/or instant in time that the image was captured. For example, the AV 30 may comprise means, such as processor 32, memory 34, sensors 39, and/or the like, for capturing an image and/or a stream of images as the AV 30 travels and/or navigates through a geographic area. In various embodiments, the image and/or at least one image of the stream of images is an aerial image (e.g., an image looking down toward the ground from above).

In an example embodiment, the AV 30 may analyze and/or process a captured image and/or stream of images to generate image data corresponding to the captured image and/or stream of images. In various embodiments, the image data corresponding to an image comprises a first representation that provides a representation of a portion of the environment surrounding the AV 30 that is pictured in and/or corresponds to a field of view of the corresponding image. In various embodiments, the first representation comprises a color-coded pixel array; a representation of a boundary, edge, line, and/or the like identified in the corresponding image data; and/or other information encoding a representation of the at least a portion of the surroundings of the AV 30 as captured in the corresponding image. Various image processing techniques, programs, machine learning-trained image processing models (e.g., segmenting models and/or the like) may be used to analyze and/or process an image to generate and/or determine corresponding image data, in various embodiments. In various embodiments, a segmenting model is a model configured to identify boundaries, edges, and/or lines within an image. For example, a segmenting model may be configured to identify roof lines, building corners, road edges, and/or other boundaries, edges, and/or lines within an image.

At block 304, the AV 30 may provide, transmit, and/or broadcast the image and/or stream of images and/or image data corresponding thereto. For example, the AV 30 may comprise means, such as processor 32, memory 34, communication interface 36, and/or the like, for providing, transmitting, and/or broadcasting the image and/or stream of images and/or image data corresponding to the image and/or to one or more images of the stream of images. In an example embodiment, the image data may correspond to one image (e.g., comprise a first representation that provides a representation of the surroundings of the AV 30 pictured in one image). In an example embodiment, the image data may correspond to multiple images (e.g., comprise a first representation that provides a representation of the surroundings of the AV 30 pictured in more than one image of the stream of images). In various embodiments, the AV 30 provides, transmits, and/or broadcasts the image and/or stream of images and/or image data corresponding thereto via a direct wireless communication (e.g., 5G, 5G short range, 5G peer-to-peer) and/or wireless broadcast. For example, the AV 30 may be located within the broadcast range of one or more edge devices 10 and the one or more edge devices 10 may receive the image and/or stream of images and/or image data corresponding thereto provided, transmitted, and/or broadcasted by the AV 30.

At block 306, the AV 30 may receive a position estimate indicating an estimated position of the AV 30 determined based at least on the provided, transmitted, and/or broadcasted image and/or stream of images and/or image data corresponding thereto. For example, the receiving a position estimate determined based at least on the provided, transmitted, and/or broadcasted image and/or stream of images and/or image data corresponding thereto. For example, an edge device 10 that received the image and/or stream of images and/or image data corresponding thereto may determine a position estimate for the AV 30 based on the image data corresponding to the image and/or stream of images and information/data stored in an image database stored by the edge device 10. In an example embodiment, the position estimate is a geographical location expressed as a latitude and longitude or latitude, longitude, and elevation/altitude. In an example embodiment, the position estimate is a relative position estimate determined relative to reference point that may be located within the broadcast region of the edge device 10 (e.g., the corner of a particular building, a point on a boundary of the broadcast region, a streetlight, and/or the like). The edge device 10 may then provide, transmit, and/or broadcast the position estimate such that the AV 30 receives the position estimate. In an example embodiment, the position estimate is received via a direct wireless communication and/or broadcast (e.g., 5G, 5G short range, 5G peer-to-peer, and/or the like).

At block 308, the AV 30 may use the position estimate to perform one or more positioning and/or navigation-related functions. For example, the AV 30 may comprise means, such as processor 32, memory 34, and/or the like, for performing one or more positioning and/or navigation-related functions using the position estimate. For example, the one or more positioning and/or navigation-related functions may comprise localization, route determination, operating the AV along a route, route travel time determination, route guidance, AV trajectory determination and/or guidance, AV speed and/or handling control, and/or the like.

### B. Example Operation of an Edge Device to Update and/or Maintain an Image Database

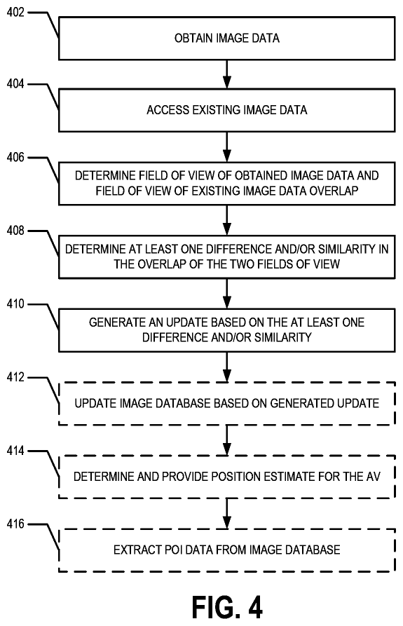

In various embodiments, an edge device 10 may store (e.g., in memory 14) an image database configured to enable visual positioning. For example, the image database may be configured to enable visual positioning of AVs 30 and/or computing devices 20 within and/or near a broadcast region of the edge device 10. FIG. 4 provides a flowchart illustrating various processes, procedures, operations, and/or the like performed, for example, by an edge device 10, to maintain and/or update an image database.

Starting at block 402, the edge device 10 obtains image data. For example, the edge device 10 may receive image data and/or a series of images and/or image data provided, transmitted, and/or broadcasted by an AV 30. For example, the edge device 10 may comprise means, such as processor 12, memory 14, communication interface 16, and/or the like, for obtaining image data. For example, when the edge device 10 receives an image or series of images, the edge device 10 may analyze and/or process the image and/or stream of images to generate image data corresponding to the captured image and/or stream of images. In various embodiments, the image data corresponding to an image comprises a first representation that provides a representation of a portion of the environment surrounding the AV 30 that is pictured in and/or corresponds to the field of view of the corresponding image. In various embodiments, the first representation comprises a color-coded pixel array; a representation of a boundary, edge, line, and/or the like identified in the corresponding image data; and/or other information encoding a representation of the at least a portion of the surroundings of the AV 30 as captured in the corresponding image. Various image processing techniques, programs, machine learning-trained image processing models (e.g., segmenting models and/or the like) may be used to analyze and/or process an image to generate and/or determine corresponding image data, in various embodiments. In various embodiments, a segmenting model is a model configured to identify boundaries, edges, and/or lines within an image. For example, a segmenting model may be configured to identify roof lines, building corners, road edges, and/or other boundaries, edges, and/or lines within an image.

At block 404, the edge device 10 may access existing image data. For example, the edge device 10 may comprise means, such as processor 12, memory 14, and/or the like for accessing, reading, and/or getting existing image data. For example, the edge device 10 may access the existing image data from the image database (e.g., stored in memory 14). In an example embodiment, the existing image data may be image data that was previously obtained by the edge device 10 that corresponds to image(s) captured by the AV 30 at an earlier point in time or captured by other AVs. In various embodiments, the existing image data comprises a second representation. In various embodiments, the second representation provides a representation of an environment. For example, the second representation may provide a representation of an environment located within and/or viewable from the broadcast region of the edge device 10. In various embodiments, the second representation comprises a color-coded pixel array; a representation of a boundary, edge, line, and/or the like identified in the corresponding image data; and/or other information encoding a representation of the at least a portion of the surroundings of the AV 30 as captured in the corresponding image.

In an example embodiment, the existing image data may be accessed based on one or more characteristics of the obtained image data. For example, the AV 30 may have provided metadata along with the image and/or stream of images and/or image data corresponding thereto that may indicate one or more characteristics of the obtained image data, such as information/data regarding the camera and/or image sensor 39 that captured the image and/or stream of images, lighting and/or weather conditions under which the image and/or stream of images were captured, an altitude from which the image was captured, and/or the like. In another example, the edge device 10 may determine characteristics of the obtained image data based on the metadata received in association with the image and/or stream of images and/or image data corresponding thereto and/or based on the time at which the image and/or stream of images and/or image data corresponding thereto is received by the edge device 10 and weather information/data corresponding to a geographical region containing the broadcast region of the edge device 10. For example, based on the time at which the image and/or stream of images and/or image data corresponding thereto is received by the edge device and/or a timestamp received in association with the image and/or stream of images and/or image data corresponding thereto, the edge device 10 may determine lighting and/or weather conditions under which the image and/or stream of images corresponding to the obtained image data were captured. In various embodiments, the existing image data is accessed based on the characteristics of the obtained image data. For example, if the obtained image data was captured under low light conditions (e.g., a nighttime), comparing the obtained image data to existing image data corresponding to images that were captured under bright light conditions (e.g., midday) may lead to identification of spurious differences. Thus, in an example embodiment, the existing image data may be selected to have characteristics that are similar to that of the obtained data. In an example embodiment, the existing image data may be filtered using a characteristic filter to have characteristics that are similar to that of the obtained data. For example, when the characteristics of the obtained image data indicates that the corresponding image(s) was captured under low light conditions, elements of the existing image data may be filtered to remove, exclude, and/or flag elements that may not be visible under low light conditions such that a comparison of the first representation of the obtained image data and the second representation of the existing image data leads to identification and/or determination of meaningful differences and/or similarities.

At block 406, the edge device 10 may determine that a field of view corresponding to the obtained image data and a field of view corresponding to the existing image data overlap at least in part. For example, the edge device 10 may determine that the environment represented by the second representation overlaps at least in part with the portion of the surroundings of the AV 30 represented in the first representation. For example, the edge device 10 may determine that at least a portion of the first representation and the second representation correspond to and/or provide representations of the same physical space or area. For example, the edge device 10 may comprise means, such as processor 12, memory 14, and/or the like, for determining that the environment represented by the second representation overlaps at least in part the surroundings of the AV 30 represented by the first representation.

In various embodiments, it may be determined whether the environment represented by the second representation overlaps at least in part with the portion of the surroundings of the AV 30 represented in the first representation based on geographic locations associated with one or more features within the first and second representations, comparing the first and second representations to determine if any elements of the first and second representation are likely to correspond to the same physical object. In various embodiments, determining whether the environment represented by the second representation overlaps at least in part with the portion of the surroundings of the AV 30 represented in the first representation comprises identifying overlapping portions of the first representation and the second representation. For example, the AV 30 may provide a position and/or heading/orientation estimate corresponding to the location and heading/orientation of the AV 30 at the time the image corresponding to the first representation was captured in association with the image data. The edge device 10 may access existing image data from the image database based on the position and/or heading/orientation estimate associated with the first representation. Based on similarities between the first representation and the second representations of the existing image data accessed from the image database, at least one second representation where the environment represented by the second representation overlaps at least in part with the portion of the surroundings of the AV 30 represented in the first representation is identified.

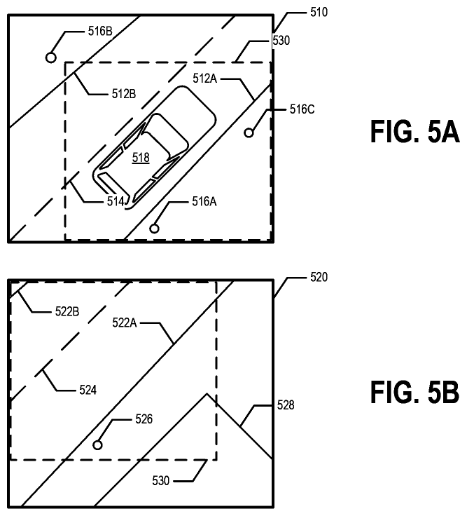

FIG. 5A illustrates an example first representation 510, according to an example embodiment. FIG. 5B illustrates an example second representation 520, according to an example embodiment. The first representation 510 and the second representation 520 comprise overlapping portions 530. For example, it may be determined that the first representation 510 and the second representation 520 comprise overlapping portions 530 by aligning road edges 512A, 512B with a corresponding one of road edges 522A, 522B, aligning center line 514 with center line 524, aligning structure 516A with structure 526, and/or the like.

Continuing with FIG. 4, at block 408, the edge device 10 identifies and/or determines at least one difference and/or at least one similarity between the first representation and the second representation. For example, the edge device 10 may identify and/or determine at least one difference and/or at least one similarity in the overlapping portions of the first representation and the second representation. For example, the differences between the second representation and the first representation and/or the overlapping portions thereof may indicate changes to the environment, features that may not be static and/or stable with time, and/or the like. For example, the similarities between the second representation and the first representation and/or the overlapping portions thereof may indicate features within the environment that are static and/or stable (at least with regard to a time frame between the capturing of an image corresponding to the existing image data and the capturing of the image corresponding to the obtained and/or received image data). For example, the edge device 10 may compare corresponding pixels of the overlapping portions of the first and second representations to identify and/or determine similarities and/or differences therebetween. For example, the edge device 10 may compare the representations of boundaries, edges, lines, and/or the like in the overlapping portions of the first and second representations to identify and/or determine similarities and/or differences therebetween. For example, the egde device 10 may use a scale-invarient feature transform (SIFT) technique to identify and/or determine similarities and/or differences between the first representation and the second representation. In various embodiments, the one or more similarities identified and/or determined between the first and second representations may be the similarities used to determine that the environment represented by the second representation overlaps at least in part with the portion of the surroundings of the AV 30 represented in the first representation and/or may be additional similarities that were not used in the determination of the overlap.

For example, for the example first representation 510 and the example second representation 520, the edge device 10 may determine that the overlapping portions 530 comprise corresponding elements road edges 512A, 522A, 512B, 522B, road center lines 514, 524, and structure 516A, 526. Thus, these elements of the first and second representations 510, 520 may be identified as and/or determined to be similarities between the first representation 510 and the second representation 520. It may be determined that elements in the overlapping portion 530 of the first representation 510 that do not have corresponding and/or aligning elements in the overlapping portion 530 of the second representation 520 and/or elements in the overlapping portion 530 of the second representation 520 that do not have corresponding and/or aligning elements in the overlapping portion 530 of the second representation 520. For example, structure 516C in the first representation does not have a corresponding and/or aligning element in the second representation 520. In another example, vehicle 518 in the first representation 510 does not have a corresponding and/or aligning element in the second representation 520. In another example, boundary 528 in the second representation does not have a corresponding and/or aligning element in the first representation 510. Structure 516B is outside of the overlapping portion 530 of the first representation 510, and therefore may not be considered when determining and/or identifying the similarities and/or differences between the first and second representations 510, 520.

Returning to FIG. 4, at block 410, the edge device 10 may generate an update for the image database based on at least one of the identified and/or determined differences and/or similarities. For example, the edge device 10 may comprise means, such as processor 12, memory 14, and/or the like for generating an update for the image database based on at least one of the identified and/or determined differences and/or similarities. In an example embodiment, the generated update is associated with characteristics associated with the obtained image data (e.g., lighting and/or weather conditions, such as visibility, cloud ceiling, and/or the like, under which the corresponding image was captured and/or the like). In various embodiments, the updates may be configured to update a confidence level of an element of the existing image data based on whether a corresponding and/or aligning element was identified and/or determined in the overlapping portion of the first representation. In various embodiments, the updates may be configured to add an element identified in the overlapping portion of the first representation that is not present in the second representation of the existing image data to the second representation. In various embodiments, the update may be configured to update the image database based on the identified and/or determined differences and/or similarities so as to provide more accurate and/or higher confidence position estimates.

At block 412, the image database is updated based on the generated update. In various embodiments, the edge device 10 may update the image database based on and/or by applying the generated update. For example, the edge device 10 may comprise means, such as processor 12, memory 14, and/or the like, for updating the image database based on and/or by applying the generated update. In an example embodiment, before the image database is updated based on the generated update, the update may be confirmed by one or more second instances of obtained image data. For example, multiple instances of obtained image data may be obtained that each correspond to a field of view that includes a particular element that was identified and/or determined to be a difference or similarity between the first instance of obtained image data and the existing image data. Each of the multiple instances of obtained image data may be compared to the existing image data to confirm and/or to adjust a confidence level of the identified and/or determined difference or similarity for the particular element between the first instance of obtained image data and the existing image data, in an example embodiment. In an example embodiment, pairs of the second instances of obtained image data (and/or a second instance of obtained image data and the first instance of obtained image data) may be compared to confirm and/or to adjust a confidence level of the identified and/or determined difference or similarity for the particular element between the first instance of obtained image data and the existing image data, in an example embodiment. In an example embodiment, when an identified and/or determined difference or similarity has been confirmed a particular number of times or is associated with a confidence level that meets or exceeds a threshold confidence level, an update corresponding to the particular element (e.g., the identified and/or determined difference or similarity) may be generated and/or applied or used to update the image database.

In various embodiments, based on comparing the second instances of obtained image data to each other, the first instance of obtained image data, and/or the existing image data, it may be determined whether the identified and/or determined differences and/or similarities correspond to the characteristics of the obtained image data (e.g., weather, lighting, and/or other conditions under which the image(s) corresponding to the obtained image data were captured). When it is determined that the identified and/or determined differences and/or similarities correspond to the characteristics of the obtained image data, the image database may be updated to indicate that the elements of the second representation corresponding to the identified and/or determined differences and/or similarities correspond to particular characteristics of the obtained image data.

In various embodiments, at block 414, the edge device 10 may determine a position estimate for the AV 30 based on the obtained image data and the existing image data and provide the position estimate such that the AV 30 may receive the position estimate. For example, the edge device 10 may comprise means, such as processor 12, memory 14, communication interface 16, and/or the like for determining a position estimate for the AV 30 based on the obtained image data and the existing image data and providing the position estimate such that the AV 30 may receive the position estimate. For example, a visual positioning technique may be used to determine a position estimate for the AV 30 based on the obtained image data and the information/data stored in the image database. The position estimate may then be communicated to the AV 30 via a direct wireless communication and/or wireless broadcast (e.g., 5G, 5G short range, 5G peer-to-peer, and/or the like).

In various embodiments, at block 416, the edge device 10 may extract POI information/data from the image database. For example, the edge device 10 may comprise means, such as processor 12, memory 14, and/or the like for extracting POI information/data from the image database. For example, the (updated) image database may be analyzed to identify representations of POI present in the second representations provided by the existing image data stored in the image database. Information/data regarding the corresponding POI may be extracted from the second representations. For example, the location of a store front, the location of an entry door in a store front, a store name, store hours, a telephone number, and/or the like may be extracted from the second representations. The extracted POI information/data may be used to update corresponding POI data records stored in a geographic database stored by the edge device 10 and/or provide (e.g., via one or more wired and/or wireless networks 50) such that a server responsible for updating a geographic database and/or digital map may use the extracted POI information/data to update a geographic database stored, for example, by the server.

### C. Example Operation of an Edge Device to Provide a Street Perspective View

In various embodiments, the edge device 10 may be configured to use the aerial image data obtained from AVs 30 and stored in the image database to enable visual positioning and/or other positioning and/or navigation-related functions for ground-based computing devices (e.g. vehicle apparatuses configured to perform automated driving functions, advanced driver assistance systems (ADAS), vehicle and/or pedestrian navigation devices, mobile phones, smart watches, tablets, laptops, heads-up displays, and/or other devices or apparatuses that may be used for assisting in ground-based navigation). For example, the edge device 10 may be configured to transform the aerial image data to street perspective view image data and/or images. For example, the edge device 10 may be configured to execute a projection process to transform the aerial (e.g., birds eye view) image data to generate a street perspective view image. As noted above, the existing image data stored in the image database provides second representations that represent portions of the environment within and/or viewable from the broadcast region of the edge device 10. The street perspective view image generated by transforming the existing image data may provide a representation of a portion of the environment within and/or viewable from the broadcast region of the edge device 10 from the perspective of a person or sensor (e.g., image sensor 29) that is generally located within a couple meters of the ground and/or floor.

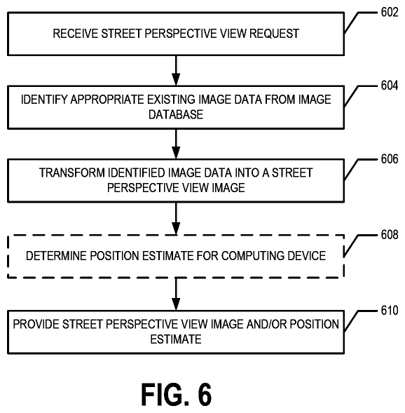

FIG. 6 provides a flowchart illustrating processes, procedures, operations, and/or the like that may be performed by the edge device 10 to provide a street perspective view image and/or to use the aerial existing image data to perform positioning for a ground-based computing device 20. Starting at block 602, the edge device receives a street perspective view request. For example, a computing device 20 located within the broadcast region of the edge device 10 may transmit and/or broadcast (e.g., via a direct wireless communication) a street perspective view request. The edge device may receive the street perspective view request (e.g., via the direct wireless communication). For example, the edge device 10 may comprise means, such as processor 12, memory 14, communication interface 16, and/or the like, for receiving the street perspective view request.

In various embodiments, the street perspective view request may comprise a location of the computing device 20. In various embodiments, the street perspective view request may comprise a pose, attitude, and/or heading of the computing device 20. In various embodiments, the street perspective view request may comprise a street perspective image captured by an image sensor 29 of the computing device 20 and/or street perspective view image data corresponding to a street perspective image captured by an image sensor 29 of the computing device 20.

At block 604, the edge device 10 may identify the appropriate existing image data from the image database. For example, the edge device 10 my comprise means, such as processor 12, memory 14, and/or the like, for identifying the appropriate exiting image data from the image database. For example, when the street perspective view request comprises a location of the computing device 20, the appropriate existing image data may be determined based thereon. For example, the existing image data corresponding to the location of the computing device 20 may be identified as the appropriate existing image data. When the street perspective view request comprises a street perspective view image captured by the computing device 20, the street perspective view image may be analyzed and/or processed to generate and/or determine street perspective image data. The appropriate existing image data may be identified based on aligning one or more elements of the street perspective image data with one or more elements of the existing image data. For example, elements within the existing image data that corresponding to one or more elements within the street perspective image data may be identified and used to identify and/or determine the appropriate existing image data.

At block 606, the edge device 10 may transform the identified existing image data into a street perspective view image. For example, the edge device 10 may comprise means, such as processor 12, memory 14, and/or the like, for transforming the identified existing image data into street perspective view image. For example, an inverse of a birds eye view projection may be used to transform and/or map the existing (aerial/birds eye view) image data into a street perspective view image. For example, the perspective of the existing image data may be warped and/or otherwise transformed to generate a street perspective view image from the aerial existing image data. In various embodiments, only selected elements of the existing image data are transformed into the street perspective view image. For example, the street perspective view image may not include all of the features present in the identified existing image data, in an example embodiment. In an example embodiment, a heading, attitude, and/or pose of the computing device 20 provided in the street perspective view request is used to determine the elements of the existing image data to transform into the street perspective view image, the line of sight direction of the street perspective view image, and/or the like. In an example embodiment, the street perspective view image may be a panoramic image and/or wide format image that may include a range of line of sight directions.

At block 608, the edge device 10 may use the street perspective view image generated by the edge device 10 a street perspective view image provided in the street perspective view request to determine a position estimate for the computing device 20. For example, the position estimate may be determined using a visual positioning technique. For example, the edge device 10 may comprise means, such as processor 12, memory 14, and/or the like for determining a position estimate for the computing device 20 based on the street perspective view image generated by the edge device 10 a street perspective view image provided in the street perspective view request to determine a position estimate for the computing device 20.

At block 610, the edge device 10 may provide (e.g., transmit, broadcast, and/or the like) the street perspective view image and/or the position estimate. For example, the edge device 10 may comprise means, such as processor 12, memory 14, communication interface 16, and/or the like for providing (e.g., transmitting, broadcasting, and/or the like) the street perspective view image and/or the position estimate. For example, the street perspective view image and/or the position estimate may be provided via a direct wireless communication such that the computing device 20 receives the perspective view image and/or the position estimate.

### D. Example Operation of a Computing Device

In various embodiments, a computing device 20 (e.g. vehicle apparatuses configured to perform automated driving functions, advanced driver assistance systems (ADAS), vehicle and/or pedestrian navigation devices, mobile phones, smart watches, tablets, laptops, heads-up displays, and/or other devices or apparatuses that may be used for assisting in ground-based navigation) may be configured to leverage the image database stored by an edge device 10 to aid the computing device 20 in performing one or more positioning and/or navigation-related functions. For example, the computing device 20 may leverage the image database to aid in the performance of one or more positioning and/or navigation-related functions such as localization, route determination, lane level route determination, operating a vehicle along a lane level route, route travel time determination, lane maintenance, route guidance, lane level route guidance, provision of traffic information/data, provision of lane level traffic information/data, vehicle trajectory determination and/or guidance, vehicle speed and/or handling control, route and/or maneuver visualization, provision of safety alerts, display of an icon or symbol indicating the location of a computing device overlaid on a visualization of a portion of a digital map, and/or the like.

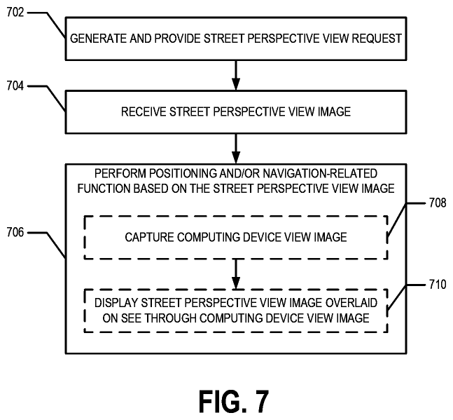

FIG. 7 provides a flowchart illustrating various processes, procedures, operations, and/or the like performed, for example, by a computing device 20 to leverage the image database stored by the edge device 10 to aid in performing one or more ground-based positioning and/or navigation-related functions. Starting at block 702, a computing device 20 may generate and provide a street perspective view request. For example, the computing device 20 may comprise means, such as processor 22, memory 24, communication interface 26, user interface 28, sensors 29, and/or the like, for generating and providing a street perspective view request. For example, user interaction with the user interface 28, movement of the computing device 20 (e.g., as determined based on measurements captured by the sensors 29), determination that a GNSS-based position for the current location of the computing device 20 is of low quality, and/or the like may trigger the generation and provision of a street perspective view request. In an example embodiment, a street perspective view request may comprise a location of the computing device 20, a street perspective view image captured by the computing device 20, and/or street perspective view image data corresponding to the street perspective view image captured by the computing device 20. In various embodiments, the street perspective view request is provided (e.g., transmitted, broadcasted, and/or the like) via a direct wireless communication (e.g., 5G, 5G short range, 5G peer-to-peer, and/or the like). For example, the street perspective view request may be provided such that an edge device 10 corresponding to a broadcast region that the computing device 20 is located in may receive the street perspective view request.

At block 704, the computing device 20 may receive a street perspective view image generated based on existing image data stored in the image database stored by the edge device 10. For example, the computing device 20 may comprise means, such as processor 22, memory 24, communication interface 26, and/or the like, for receiving the street perspective view image that was generated by the edge device 10. For example, the computing device 20 may receive the street perspective view image via a direct wireless communication (e.g., 5G, 5G short range, 5G peer-to-peer, and/or the like). In an example embodiment, the computing device 20 may receive a position estimate for the location of the computing device 20 that was determined by the edge device 10 using a visual positioning technique.

At block 706, the computing device 20 may use the received street perspective view image and/or position estimate to perform one or more positioning and/or navigation-related functions. For example, the computing device 20 may comprise means, such as processor 22, memory 24, user interface 26, sensors 29, and/or the like, for performing one or more positioning and/or navigation-related functions based at least in part and/or using the received street perspective view image and/or position estimate. Some non-limiting examples of positioning and/or navigation-related functions comprise localization, route determination, lane level route determination, operating a vehicle along a lane level route, route travel time determination, lane maintenance, route guidance, lane level route guidance, provision of traffic information/data, provision of lane level traffic information/data, vehicle trajectory determination and/or guidance, vehicle speed and/or handling control, route and/or maneuver visualization, provision of safety alerts, display of an icon or symbol indicating the location of a computing device overlaid on a visualization of a portion of a digital map, and/or the like.

In an example embodiment, the computing device 20 may perform a positioning and/or navigation-related function that comprises displaying a see-through augmented reality user interface. For example, the computing device 20 may display the received street perspective view image (and/or a portion thereof) via user interface 28. The computing device 20 may further display an image captured by an image sensor 29 of the computing device 20. At least a portion of the image captured by the image sensor 29 may be displayed in a see through manner such that components of the street perspective view image generated by the edge device 10 that are located behind the at least a portion of the image captured by the image sensor 29 may be visible.

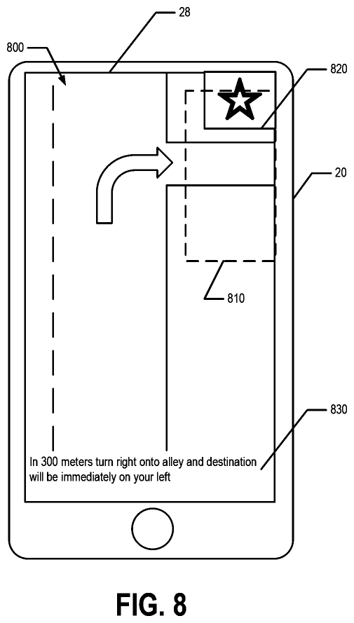

For example, at block 708, the computing device 20 may capture an image (e.g., a street perspective view image). For example, the computing device 20 may comprise means, such as processor 22, memory 24, sensors 29, and/or the like for capturing an image. In various embodiments, the image provides a depiction of a portion of the surroundings of the computing device 20. At block 710, the computing device 20 may display the received street perspective view image (e.g., generated by the edge device 10) via the user interface 28. The computing device 20 may display the image captured by the computing device 20 as an overlay on the received street perspective view image (e.g., via the user interface 28). The image captured by the computing device 20 may displayed with at least a portion of the image displayed in a see-through manner. For example, the opacity of at least a portion of the image may be reduced such that components of the street perspective view image generated by the edge device 10 may be visible through the at least a portion of the image captured by the computing device 20 that is displayed in the see-through manner. For example, FIG. 8 provides an example view 800 of a user interface 28 with a portion 810 (e.g., corresponding to a building, structure, and/or the like) is displayed in a see through manner such that component 820 (which in the illustrated example is a destination of a route being navigated) of the street perspective view image generated by the edge device 10 is visible in the display even through the component 820 may not be visible in the image captured by the computing device 20. The view 800 of the user interface 28 may also include maneuver instructions 830 configured to guide a user in performing an upcoming maneuver of a route.

### III. Technical Advantages

Various embodiments provide technical solutions to the technical problems of enabling accurate determination of a location of an AV when the AV is located in an area where GNSS-based positioning may fail and/or not have sufficient accuracy. Various non-GNSS-based positioning techniques are Cloud-based solutions that require communication with various computing entities via one or more networks. However, this can result in significant latency in the AV receiving the position estimate. Various embodiments provide a solution for quickly providing an accurate position estimate to an AV by storing a local image database at an edge device 10. For example, the image database stored by the edge device 10 may comprise image data that provides representations of the environment within and/or viewable from a broadcast region of the edge device 10. Thus, an AV 30 may communicate directly with an edge device 10 located near the AV 30 to obtain an accurate position estimate without encountering the latency of needing to communicate with various other computing entities via a network and/or the like.

Additionally, various embodiments provide a solution for maintaining and/or updating the image database such that changes in the environment within and/or viewable from a broadcast region of the edge device 10 may be timely captured in an automated manner. Objects within the environment that are more or less visible under various conditions (e.g., weather and/or lighting conditions, etc.) may be identified and catalogued such that the image database may enable accurate, low latency visual positioning under a wide variety of conditions.

Moreover, various embodiments leverage the local image database stored by the edge device 10 to enable the performance of various positioning and/or navigation-related functions by a ground-based computing device 20. For example, the edge device 10 may transform aerial image data stored in the image database to generate street perspective view images. A computing device 20 may display a street perspective view image generated by the edge device 10 to enable a user to visualize a maneuver of a route, a destination of the route, and/or the like. Thus, the local image database stored by the edge device 10 may also be used to improve user experience of a navigation-related user interface by aiding user visualization of maneuvers, destinations, and/or the like that may not be visible from the user's perspective. The edge device 10 may also leverage the image database to generate and provide accurate position estimates for ground-based computing devices 20 using a visual positioning technique in a low latency manner.

Thus, various embodiments of the present invention provide a local image database stored by an edge device 10 that may be generated, updated, and/or maintained based on images captured by AVs 30 and that provide various improvements to the technical fields of positioning and/or navigation for both aerial vehicles and ground-based computing devices.

### IV. Example Apparatus

The edge device 10 and/or computing device 20 of an example embodiment may be embodied by or associated with a variety of computing devices including, for example, a navigation system including a global navigation satellite system (GNSS), a cellular telephone, a mobile phone, a personal digital assistant (PDA), a watch, a camera, a computer, an Internet of things (IoT) item, router, routing switch, integrated access device, multiplexer, metropolitan area network (MAN) and/or wide area network (WAN) access device and/or other device that can communicate via a wireless communication protocol and/or that can store an image database. Additionally or alternatively, the edge device 10 and/or computing device 20 may be embodied in other types of computing devices, such as a server, a personal computer, a computer workstation, a laptop computer, a plurality of networked computing devices or the like, that are configured to interact with an AV 30, compare first and second representations to determine differences and/or similarities in an overlapping portion thereof, generate updates for an image database, update an image database, transform aerial image data into street perspective view images, perform positioning and/or navigation-related functions, and/or the like. In an example embodiment, a computing device 20 is a smartphone, tablet, other mobile device, and/or other 5G enabled device and an edge device 10 is a router, routing switch, integrated access device, multiplexer, metropolitan area network (MAN) and/or wide area network (WAN) access device. and/or other device enabling access to a network. In an example embodiment, an AV 30 is an unmanned, autonomous, semi-autonomous, and/or other aerial vehicle that may be programed and/or controlled to perform various tasks, such as capturing and providing images, item delivery and/or pickup, and/or the like.

In some embodiments, the processor 12, 22, 32 (and/or co-processors or any other processing circuitry assisting or otherwise associated with the processor) may be in communication with the memory device 14, 24, 34 via a bus for passing information among components of the apparatus. The memory device may be non-transitory and may include, for example, one or more volatile and/or non-volatile memories. In other words, for example, the memory device may be an electronic storage device (e.g., a non-transitory computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the edge device 10 and/or computing device 20 may be embodied by a computing entity and/or device and an AV 30 may comprise a computing entity and/or device (e.g., in addition to mechanical systems used for aerial navigation, item transportation, and/or the like). However, in some embodiments, the edge device 10, computing device 20, and/or the computing entity and/or device of the AV 30 may be embodied as a chip or chip set. In other words, the edge device 10, computing device 20, and/or AV 30 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 12, 22, 32 may be embodied in a number of different ways. For example, the processor 12, 22, 32 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 12, 22. 32 may include one or more processing cores configured to perform independently. A multi-core processor may enable multiprocessing within a single physical package. Additionally or alternatively, the processor 12, 22, 32 may include one or more processors configured in tandem via the bus to enable independent execution of instructions, pipelining and/or multithreading. In various embodiments, the processor 12, 22, 32 may comprise a graphical processing unit (GPU).

In an example embodiment, the processor 12, 22, 32 may be configured to execute instructions stored in the memory device 14, 24, 34 or otherwise accessible to the processor. In an example embodiment, the memory device 14 stores an image database. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the edge device 10, computing device 20, and/or AV 30 may include a user interface 18, 28, 38 that may, in turn, be in communication with the processor 12, 22, 32 to provide output to the user, such as one or more navigable routes to and/or from a planned location (e.g., a delivery location and/or a pickup location), one or more validations, confirmations, and/or substantiations of AV activity, and/or the like, and, in some embodiments, to receive an indication of a user input. As such, the user interface 18, 28, 38 may include one or more output devices such as a display, speaker, and/or the like and, in some embodiments, may also include one or more input devices such as a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor 12, 22, 32 (e.g., memory device 14, 24, 34 and/or the like).

The edge device 10, computing device 20, and/or AV 30 may optionally include a communication interface 16, 26, 36. The communication interface 16, 26, 36 may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In various embodiments, an edge device 10, computing device 20, and/or AV 30 may comprise a component (e.g., memory 14, 24, 34, and/or another component) that stores a digital map (e.g., in the form of a geographic database) comprising a first plurality of data records, each of the first plurality of data records representing a corresponding TME, wherein at least some of said first plurality of data records map information/data indicating current traffic conditions along the corresponding TME. For example, the geographic database may include a variety of data (e.g., map information/data) utilized in various navigation functions such as constructing a route or navigation path, determining the time to traverse the route or navigation path, matching a geolocation (e.g., a GNSS determined location) to a point on a map, a lane of a lane network, and/or link, one or more localization features and a corresponding location of each localization feature, and/or the like. For example, a geographic database may include road segment, segment, link, lane segment, or traversable map element (TME) data records, point of interest (POI) data records, localization feature data records, and other data records. More, fewer or different data records can be provided. In one embodiment, the other data records include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GNSS data associations (such as using known or future map matching or geo-coding techniques), for example. In an example embodiment, the data records may comprise nodes, connection information/data, intersection data records, link data records, POI data records, and/or other data records. In an example embodiment, the edge device 10 may be configured to modify, update, and/or the like one or more data records of the geographic database. For example, the edge device 10 may modify, update, generate, and/or the like map information/data corresponding to TMEs, links, lanes, road segments, travel lanes of road segments, nodes, intersection, pedestrian walkways, elevators, staircases, and/or the like and/or the corresponding data records (e.g., to add or update updated map information/data including, for example, current traffic conditions along a corresponding TME), a localization layer (e.g., comprising localization features) and/or the corresponding data records, and/or the like.

In an example embodiment, the TME data records are links, lanes, or segments (e.g., maneuvers of a maneuver graph, representing roads, travel lanes of roads, streets, paths, navigable aerial route segments, and/or the like as can be used in the calculated route or recorded route information for determination of one or more personalized routes). The intersection data records are ending points corresponding to the respective links, lanes, or segments of the TME data records. The TME data records and the intersection data records represent a road network, such as used by vehicles, cars, bicycles, and/or other entities. Alternatively, the geographic database can contain path segment and intersection data records or nodes and connection information/data or other data that represent pedestrian paths or areas in addition to or instead of the vehicle road record data, for example. Alternatively and/or additionally, the geographic database can contain navigable aerial route segments or nodes and connection information/data or other data that represent an navigable aerial network, for example.

The TMEs, lane/road/link/path segments, segments, intersections, and/or nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database can include data about the POIs and their respective locations in the POI data records. The geographic database can also include data about places, such as cities, towns, or other communities, and other geographic features, such as bodies of water, mountain ranges, etc. Such place or feature data can be part of the POI data or can be associated with POIs or POI data records (such as a data point used for displaying or representing a position of a city). In addition, the geographic database can include and/or be associated with event data (e.g., traffic incidents, constructions, scheduled events, unscheduled events, etc.) associated with the POI data records or other records of the geographic database.

The geographic database can be maintained by the content provider (e.g., a map developer) in association with the services platform. By way of example, the map developer can collect geographic data to generate and enhance the geographic database. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions. The navigation-related functions can correspond to vehicle navigation or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases. Regardless of the manner in which the databases are compiled and maintained, an edge device 10, computing device 20, and/or AV 30 in accordance with an example embodiment may determine the time to traverse a route through at least a portion of a navigable network.

### V. Apparatus, Methods, and Computer Program Products

As described above, FIGS. 3, 4, 6, and 7 illustrate flowcharts of an edge device 10, computing device 20, and/or AV 30, methods, and computer program products according to an example embodiment of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 14, 24, 34 of an apparatus employing an embodiment of the present invention and executed by the processor 12, 22, 32 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
obtaining, by one or more processors, image data corresponding to at least one image captured by an aerial vehicle (AV), the obtained image data comprising a first representation that provides a representation of at least a portion of surroundings of the AV;
accessing, by the one or more processors, existing image data from an image database, the existing image data comprising a second representation, wherein the image database is configured to at least enable visual positioning of a device;
determining, by the one or more processors, based at least in part on a comparison of the first representation and the second representation, whether the second representation provides a representation of an environment that at least partially overlaps the at least a portion of the surroundings of the AV;
based at least in part on the determination of whether the second representation represents an environment that at least partially overlaps the at least a portion of the surroundings of the AV, identifying, by the one or more processors, at least one difference or similarity in an overlap of the representation of the environment and the at least a portion of the surroundings of the AV; and
generating, by the one or more processors, an update to the image database based at least in part on the at least one difference or similarity.

2. The method of claim 1, further comprising, based at least in part on the determination of whether the second representation represents an environment that at least partially overlaps the at least a portion of the surroundings of the AV, determining a position estimate for the AV.

3. The method of claim 1, wherein the one or more processors are part of an edge device.

4. The method of claim 3, wherein the edge device stores the image database and the image database comprises image data corresponding to an environment within a broadcast region of the edge device.

5. The method of claim 4, wherein the broadcast region corresponds to a broadcast range of at least one of short range 5G transmissions or peer-to-peer 5G transmissions.

6. The method of claim 3, wherein the at least one image is a part of a stream of images.

7. The method of claim 1, wherein each of the first representation and the second representation comprise at least one of (a) a color-coded pixel array or (b) a representation of a boundary identified in the corresponding image data.

8. The method of claim 1, further comprising analyzing the at least one image to generate the first representation.

9. The method of claim 1, wherein the image data comprises a plurality of instances of image data that each correspond to a respective at least one image that provides a representation that overlaps at least in part with the environment, and the method further comprises determining a plurality of differences and/or similarities in the overlap of at least one of (a) one or more pairs of instances of image data of the plurality of instances of image data or (b) one or more instances of image data of the plurality of instances of image data and the existing image data, wherein the update to the image database is generated based on the plurality of differences and/or similarities.

10. The method of claim 1, wherein the at least one image provides an aerial view of the at least a portion of the surroundings of the AV and the existing image data stored in the image database provides an aerial view of the environment.

11. The method of claim 10, further comprising transforming the aerial view of the environment to a street perspective view and providing the street perspective view such that the street perspective view is received by a computing device for use in a positioning and/or navigation-related function.

12. The method of claim 11, wherein the computing device is configured to provide the street perspective view via a display thereof.

13. The method of claim 12, wherein the street perspective view is provided as part of a see-through virtual reality display.

14. The method of claim 1, further comprising:
generating an updated database by updating the image database based on the generated update; and
extracting point of interest data from image data stored in the updated database.

15. An apparatus comprising at least one processor, at least one memory storing computer program code, and a communications interface, the at least one memory and the computer program code configured to, with the processor, cause the apparatus to at least:
obtain image data corresponding to at least one image captured by an aerial vehicle (AV), the obtained image data comprising a first representation that provides a representation of at least a portion of surroundings of the AV;
access existing image data from an image database, the existing image data comprising a second representation, wherein the image database is configured to at least enable visual positioning of a device;
determine based at least in part on a comparison of the first representation and the second representation, whether the second representation provides a representation of an environment that at least partially overlaps the at least a portion of the surroundings of the AV;
based at least in part on the determination of whether the second representation represents an environment that at least partially overlaps the at least a portion of the surroundings of the AV, identify at least one difference or similarity in an overlap of the representation of the environment and the at least a portion of the surroundings of the AV; and
generate an update to the image database based at least in part on the at least one difference or similarity.

16. The apparatus of claim 15, wherein the at least one memory and the computer program code are further configured to, with the processor, cause the apparatus to at least, based at least in part on the determination of whether the second representation represents an environment that at least partially overlaps the at least a portion of the surroundings of the AV, determine a position estimate for the AV.

17. The apparatus of claim 15, wherein the apparatus is an edge device, the edge device stores the image database in the at least one memory, and the image database comprises image data corresponding to an environment within a broadcast region of the edge device.

18. The apparatus of claim 15, wherein each of the first representation and the second representation comprise at least one of (a) a color-coded pixel array or (b) a representation of a boundary identified in the corresponding image data.

19. The apparatus of claim 15, wherein the at least one image provides an aerial view of the at least a portion of the surroundings of the AV and the existing image data stored in the image database provides an aerial view of the environment and the at least one memory and the computer program code are further configured to, with the processor, cause the apparatus to at least:
transform the aerial view of the environment to a street perspective view, and
provide the street perspective view such that the street perspective view is received by a computing device for use in a positioning and/or navigation-related function.

20. A computer program product comprising at least one non-transitory computer-readable storage medium having computer-readable program code portions stored therein, the computer-readable program code portions comprising executable portions configured, when executed by a processor of an apparatus, to cause the apparatus to:
obtain image data corresponding to at least one image captured by an aerial vehicle (AV), the obtained image data comprising a first representation that provides a representation of at least a portion of surroundings of the AV;
access existing image data from an image database, the existing image data comprising a second representation, wherein the image database is configured to at least enable visual positioning of a device;
determine based at least in part on a comparison of the first representation and the second representation, whether the second representation provides a representation of an environment that at least partially overlaps the at least a portion of the surroundings of the AV;
based at least in part on the determination of whether the second representation represents an environment that at least partially overlaps the at least a portion of the surroundings of the AV, identify at least one difference or similarity in an overlap of the representation of the environment and the at least a portion of the surroundings of the AV; and
generate an update to the image database based at least in part on the at least one difference or similarity.
